(19) United States
(12) Patent Application Publication
(10) Pub. No.: US 2013/0340875 A1
(43) Pub. Date: Dec. 26, 2013

(54) FOLDED BELLOWS

(71) Applicant: A & A Manufacturing Co., Inc., New Berlin, WI (US)

(72) Inventor: Steven Piacsek, Waukesha, WI (US)

(73) Assignee: A & A Manufacturing Co., Inc., New Berlin, WI (US)

(21) Appl. No.: 13/926,306

(22) Filed: Jun. 25, 2013

Related U.S. Application Data
(60) Provisional application No. 61/664,275, filed on Jun. 26, 2012.

(51) Int. Cl. F16L 11/00

(52) U.S. Cl. CPC F16L 11/00
USPC 138/121

(57) ABSTRACT

A bellows design and a method of making such a bellows design are disclosed. The method of producing a folding bellows is simple in construction, utilizes assembly methods which are not complex, uses inexpensive materials, and provides protection similar to more complicated and expensive bellows. The bellows construction uses two basic components, a flat piece of flexible material and formed frame which are used in conjunction with each other to produce the folding bellows.

### CROSS-REFERENCE TO RELATED APPLICATION

This application is based on and claims priority to U.S. Provisional Patent Application No. 61/664,275 filed on Jun. 26, 2012, which is incorporated herein by reference in its entirety for all purposes.

### FIELD OF THE INVENTION

The present invention relates generally to the field of protective covers. More particularly, the present invention relates to the design and construction of a folding bellows.

### BACKGROUND

Folding bellows are used to protect many items that move and need to be protected throughout a range of movement. Bellows are typically used to prevent items from getting into an area that needs to be protected. Some examples of the use of bellows are to protect machinery from industrial hazards such as metal chips or other debris, to protect outdoor equipment from environmental hazards such as rain or snow, or to provide a transport route for air or powder. Bellows are also frequently used to prevent people from accessing the interior of equipment that may cause harm such as a scissors type lifting device.

There are many methods of manufacturing such bellows but it has been standard in the industry to have the bellows produced in such a manner as to create panels and hinges in some manner such that the entire bellows can allow for extending to an open position or retracting to a closed position and be able to repeat this movement while maintaining the original shape. The shape is defined by the manner in which the panels fold together.

One method of producing a bellows is to use flexible fabric and alternately stitch together the inside and outside edges thus creating hinges at the inside and outside and allowing the fabric portion between the stitched edges to act as the panel. This construction may be enhanced by stitching in plastic or metallic rods at either of, or both of, the material edges. See, for example, U.S. Pat. No. 4,579,045.

Another method of producing a bellows is to laminate many plies of materials and material strips together while leaving a small gap between the material strips. When the laminated sheet is folded, the gaps act as the hinges and the strips act as the panels. See, for example, U.S. Pat. Nos. 5,021,271; 4,745,848; and 4,638,722. A similar method of producing a bellows is to produce a sheet that utilizes a rigid plastic panel that alternates with a flexible plastic hinge to create the folding mechanism. See, for example, U.S. Pat. Nos. 4,662,734 and 6,986,938.

Yet another method of producing a bellows is to create a plastic or metallic frame to which flexible material is attached. The material then folds itself between frame members. The frame members are typically located at the exterior of the bellows shape. Each of these methods of manufacturing a folding bellows are costly to produce due to the assembly method needed to create the folding panel and hinge structure, the amount of material that is needed to produce the folding structure, or the time that is needed to produce the folding structure.

As such, there is a need for a method of manufacturing a folding bellows that will provide a similar function as other folding bellows but designed in such a manner as to reduce the cost by simplifying the method of manufacturing and reducing the amount and type of material used.

### SUMMARY

The present invention relates to a bellows having a covering panel formed into a continuous generally tube shape by securing an end thereof to another end thereof. The bellows includes a plurality of U-shaped channel frames having jaws for receiving and securing portions of the covering panel. The U-shaped channel frames are located inside the tube shape and are secured to two opposing sides of the covering panel to create a formed folding shape leaving two sides adjacent the formed folding shape sides as floating sides.

In an alternative embodiment, the bellows includes a plurality of outer frames that are secured to the outer surface of the tube shape. Frame stiffeners are inserted into each channel frame on the floating sides and connect the channel frames to the outer frames thereby trapping the tube shape inside the outer frames.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view that depicts one embodiment of a folded bellows in accordance with the invention shown in a retracted position;

FIG. 2 is a perspective view of the folded bellows of FIG. 1 shown in an extended position;

FIG. 3 is another perspective view of the folded bellows of FIG. 1 showing two adjacent sides of the folding bellows;

FIG. 4 is another perspective view of the folded bellows of FIG. 1 showing the inside of two adjacent sides of the folding bellows;

FIG. 5 is a top view of the folded bellows of FIG. 1 with dashed lines indicating the position of the forming frame pieces;

FIG. 6 is a section view of the folded bellows of FIG. 1 taken generally along the line 6-6 of FIG. 5 showing the folding bellows in a retracted position;

FIG. 7 is a section view of the folded bellows of FIG. 1 taken generally along the line 6-6 of FIG. 5 showing the folding bellows in an extended position;

FIG. 8 is a section view of the folded bellows of FIG. 1 taken generally along the line 8-8 of FIG. 5 showing the folding bellows in a retracted position;

FIG. 9 is a section view of the folded bellows of FIG. 1 taken generally along the line 8-8 of FIG. 5 showing the folding bellows in an extended position;

FIG. 10 is a perspective view of another embodiment of a folded bellows in accordance with the invention showing the folded bellows in an extended position;

FIG. 11 is a top view of the folded bellows of FIG. 10 with dashed lines indicating the position of the forming frame pieces;

FIG. 12 is a section view of the folded bellows of FIG. 10 taken generally along the line 12-12 of FIG. 11 showing the folding bellows in a retracted position;

FIG. 13 is a section view of the folded bellows of FIG. 10 taken generally along the line 12-12 of FIG. 11 showing the folding bellows in an extended position;

FIG. 14 is a section view of the folded bellows of FIG. 10 taken generally along the line 14-14 of FIG. 11 showing the folding bellows in a retracted position; and

FIG. 15 is a section view of the folded bellows of FIG. 10 taken generally along the line 14-14 of FIG. 11 showing the folding bellows in an extended position.

### DETAILED DESCRIPTION

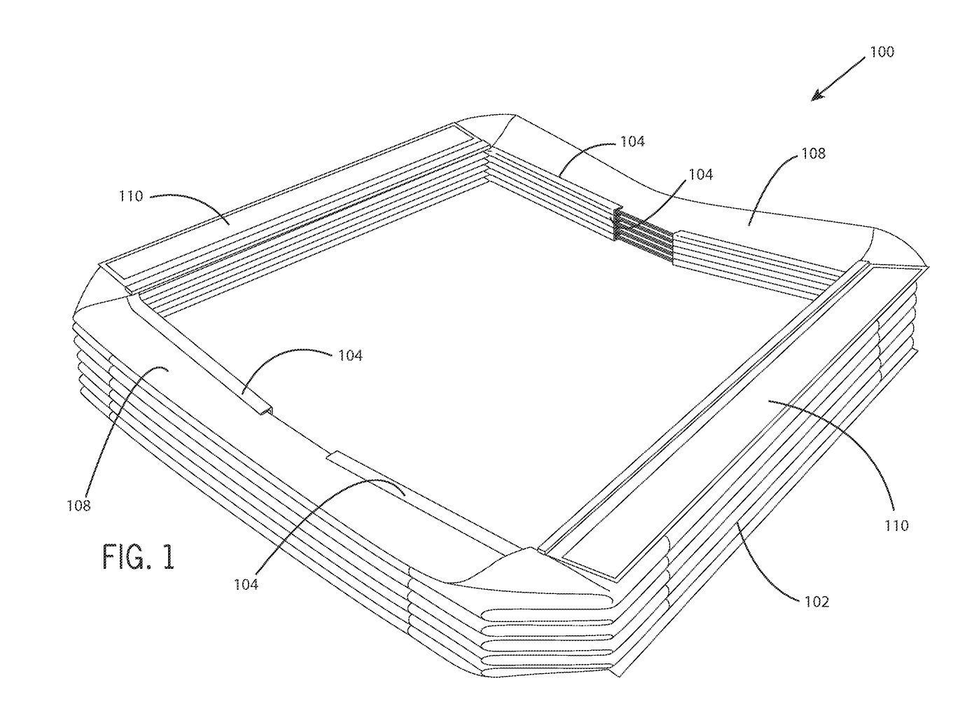

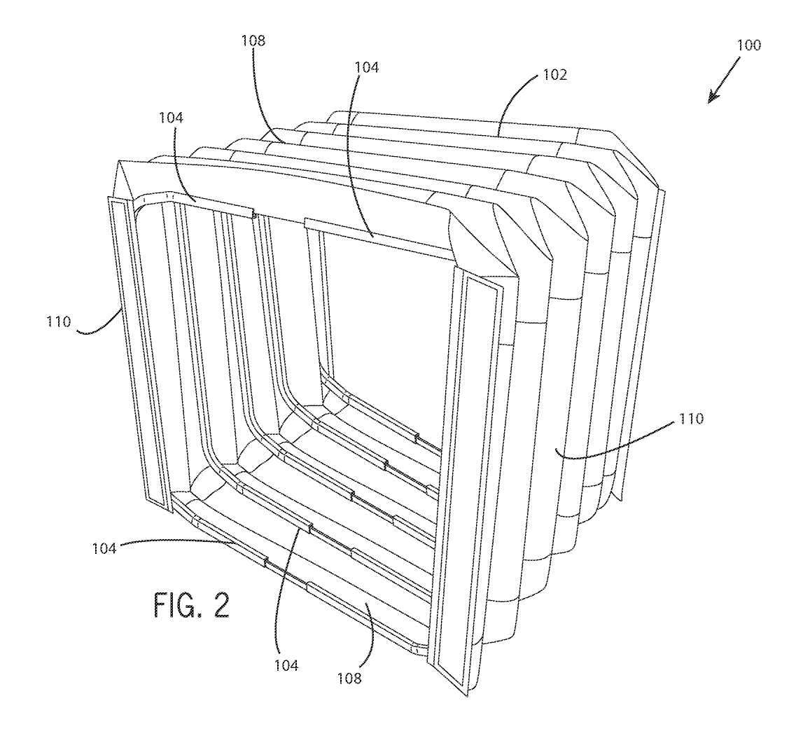

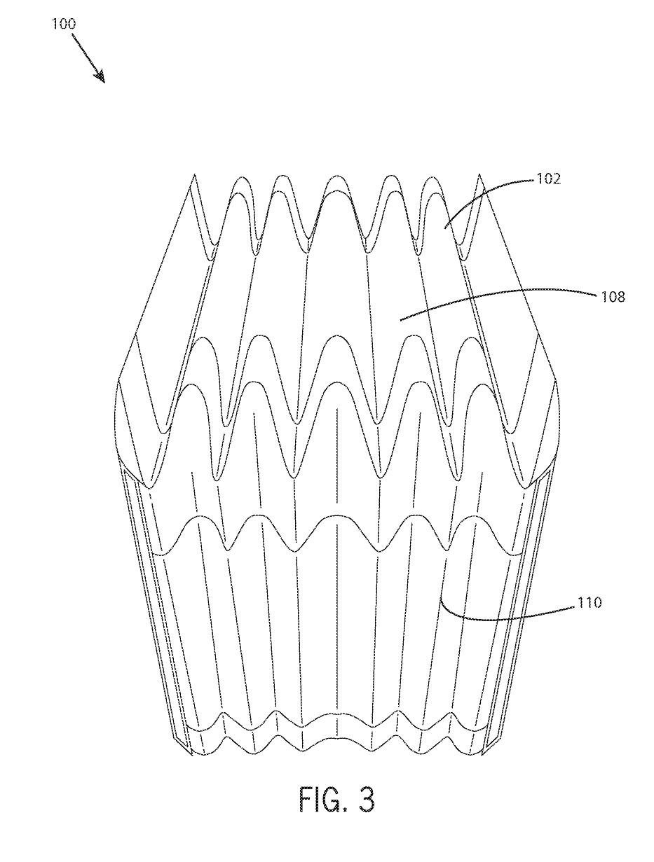

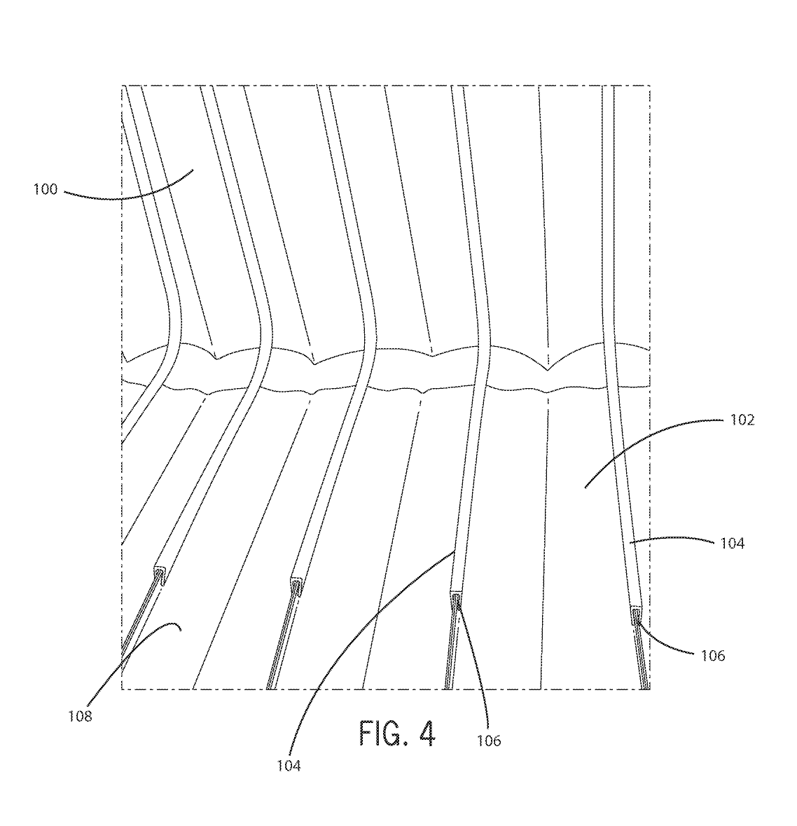

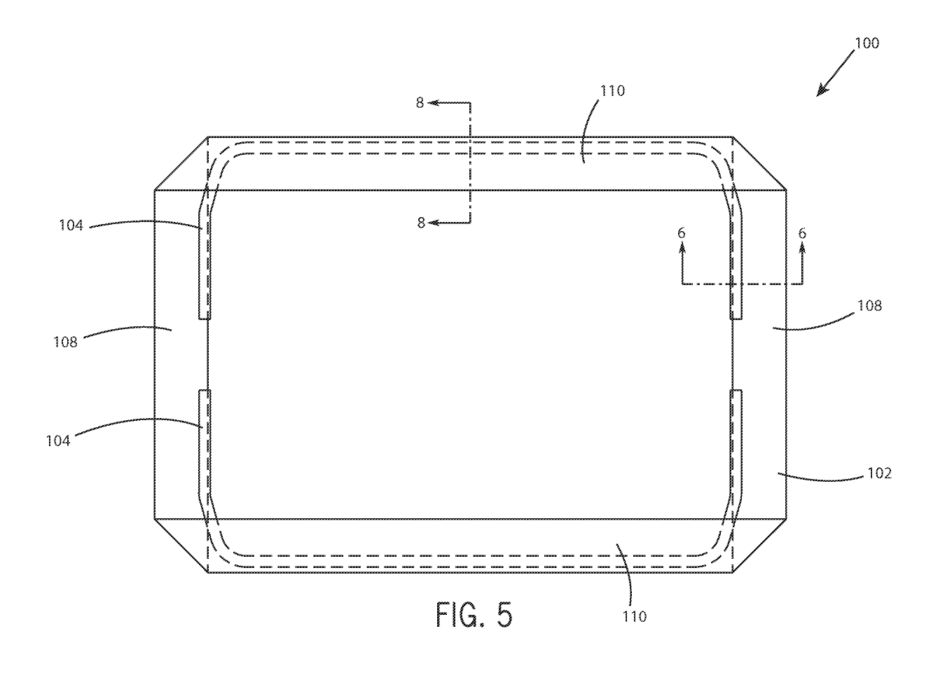

Turning now to FIGS. 1-9, one embodiment of a folding bellows 100 in accordance with the invention shown. The folding bellows 100 is designed and manufactured in such a manner that involves a flat piece of flexible material 102 and a plurality of forming frames 104. In the embodiment shown, the flat piece of flexible material 102 is one single sheet that is formed into a tube shape by adhering one end to another with a seam. The tube shape may also be assembled with multiple smaller pieces of flexible material 102 but with the same resulting tube shape that is created if a single piece of material is used. Alternatively, if the folding bellows 100 has a zipper or similar closure, or the folding bellows are not completely enclosed (i.e. three sided), a tube will not need to be created. Additionally, the flexible material 102 can be any type of flexible material including, but not limited to thermoplastic, elastomer, or thermoplastic elastomer film or coated fabric.

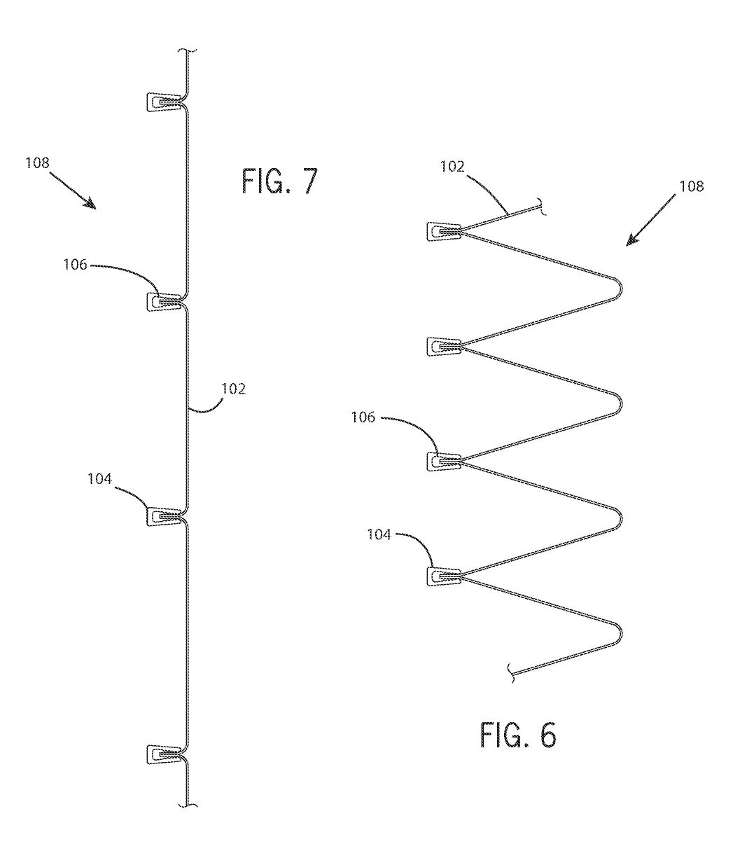

The forming frames 104 that are used in this design have a U-shaped cross section, and have a jaw 106 that can receive the flexible material 102 from which the tube is made. FIGS. 6-7 are cross-sectional views that show how the flexible material 102 is received in the jaw 106. FIG. 6 shows the folding bellows 100 in a collapsed position, and FIG. 7 shows the folding bellows in an extended position. The forming frames 104 can also be a continuous solid shape or another shape which is capable of connecting it to the flexible material 102. The connection means may be by bonding, wrapping, sealing, crimping, or other method to fix each forming frame 104 to the flexible material 102.

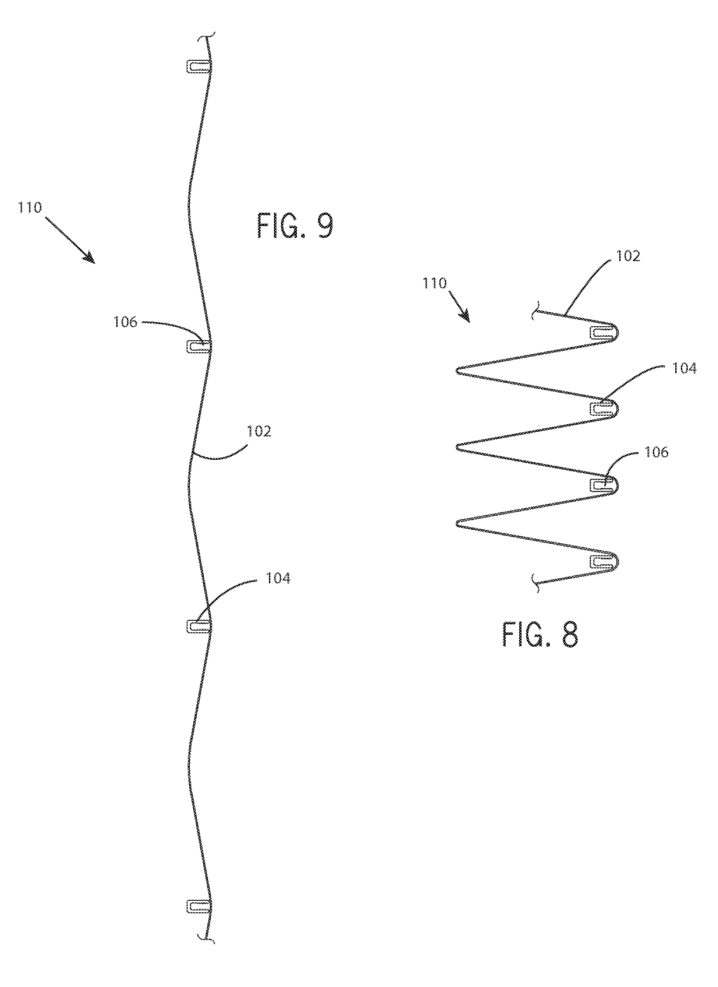

The forming frames 104 are fixed to the flexible material 102 on just two opposing sides which will be referred to as the formed sides 108. The forming frames 104 help create a formed folding shape on the formed sides 108 because the forming frames are fixed to the flexible material 102 on these two sides. The two sides adjacent to the formed sides 108 do not have any connection means between the flexible material 102 and the forming frames 104. These will be referred to as the floating sides 110. The flexible material 102 on the floating sides 110 takes its shape from the adjacent sides, the corner folding method, and from the length of flexible material on the floating sides being longer than the available length of flexible material on the formed side in the extension axis. FIGS. 8-9 are cross-sectional views showing one of the floating sides 110. FIG. 8 shows the folded bellows 100 in the collapsed position, and FIG. 9 shows the folded bellows in the extended position. By having two floating sides 110, the time to create the folds on these sides is minimal because the folds are created simply as a function of the two formed sides 108 and not as a result of a direct creation of the folds in a manner such as stitching, bonding, or layering. The forming frames 104 extend across the floating side 110 to provide a means by which the flexible material 102 of the floating sides maintains its folds between the two formed sides 108 and also provides physical stiffness to the floating sides as a means of protection from objects coming into contact with the floating side. Each forming frame 104 is used to provide definition for one fold with the number of folds required for a given extended length determining the number of forming frames to be used. The forming frames 104 can be manufactured from any suitable material including metallic or plastic materials. The forming frames 104 may be formed to the desired bellows shape or they may be assembled from multiple pieces to create the desired bellows shape.

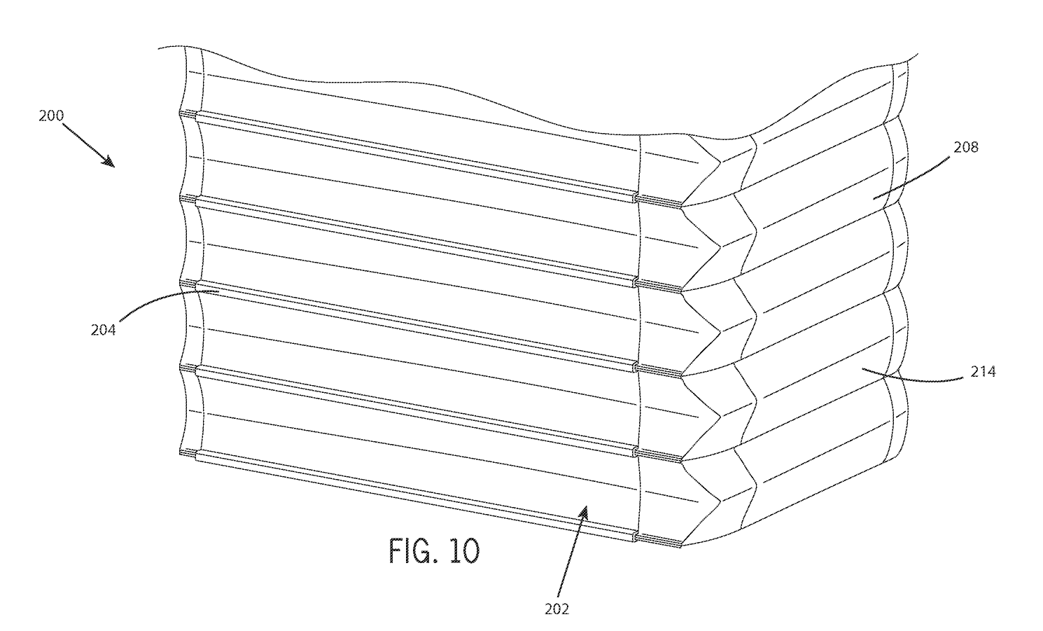

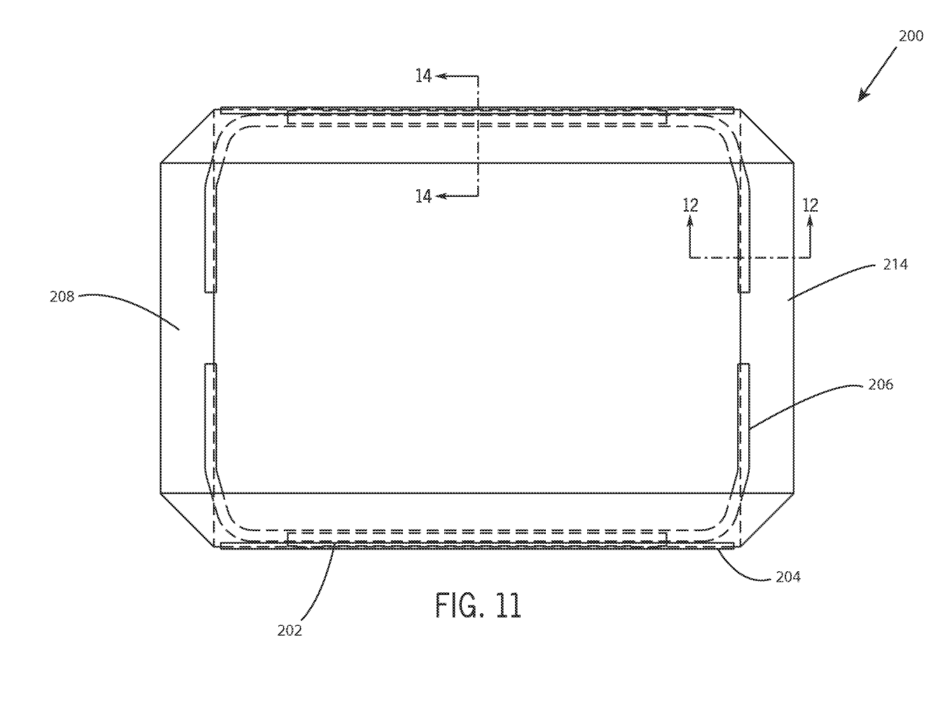

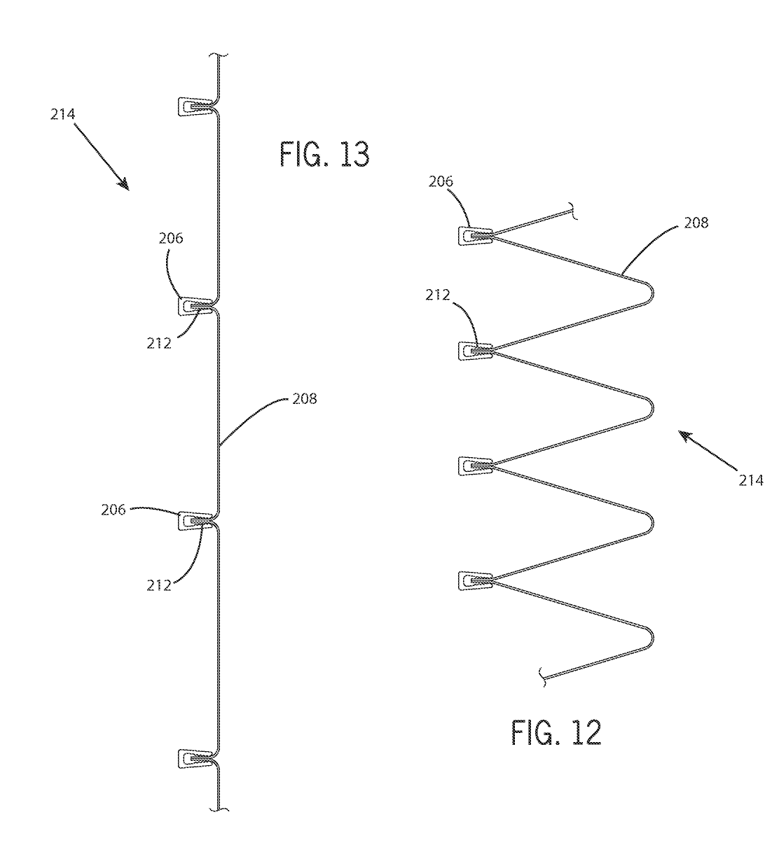

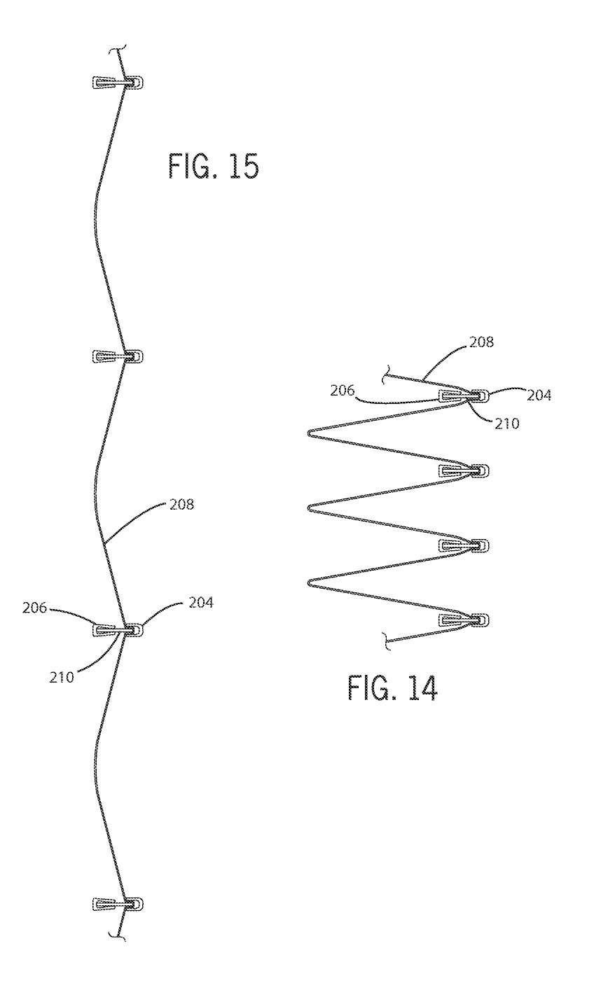

FIGS. 10-15 show another embodiment of a folding bellows 200 in accordance with the invention. The folding bellows 200 has floating sides 202 that utilize an outer frame 204 that will connect to an inner forming frame 206. Including the outer frame 204 helps stiffen inner forming frames 206 located inside the folding bellows 200 or to prevent the flexible material 208 from being pushed outward in instances that have internal air pressure applied to the interior of the folding bellows 200. In the embodiment shown, a frame stiffener 210 is inserted into each inner frame 206. The frame stiffener 210 connects the inner frames 206 to the outer frames 204 thereby trapping the flexible material 208 inside the outer frames as part of the connection process. As in the previously described embodiment, the inner forming frames 206 have a U-shaped cross section, and have jaws 212 that can receive the flexible material 208 from which the tube is made, thereby creating formed sides 214. As shown, FIG. 14 is a section view showing the folding bellows 200 in a collapsed position, while FIG. 15 is another section view showing the folding bellows in an extended position.

One method of manufacturing folding bellows 100, 200 in accordance with the invention is to identify locations on a tube of flexible material 102, 208 where the forming frames 104, 206 will connect to the flexible material. The connection method between the forming frames 104, 206 and the flexible material 102, 208 is then performed resulting in a series of forming frames that are connected to the flexible material in set positions in the perimeter of the tube and in an equal spaced means from one tube end to the other tube end. The set positions may be determined by any suitable means, including but not limited to marking, pleating, slitting, or sealing. A folding method is then used to create the folds of the folding bellows 100, 200. The folds alternate from one side to the adjacent side. The folds which protrude inward on the formed side 108, 214 will protrude outward on the adjacent floating side 110, 214 and vice versa.

The use of a folding bellows 100, 200 in accordance with the invention may commonly be used on a scissors type lift which utilizes the folding bellows to cover the scissors mechanism and to prevent people from getting injured by accidently placing a body part into the mechanism.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A bellows comprising:
a covering panel formed into a continuous generally tube shape by securing an end thereof to another end thereof;
a plurality of U-shaped channel frames having jaws for receiving and securing portions of the covering panel; and
wherein the frames are secured to two opposing sides of the covering panel to create a formed folding shape leaving two sides adjacent the formed folding shape sides as floating sides.

2. The bellows of claim 1, wherein the covering panel is made of a flexible material.

3. The bellows of claim 1, wherein the plurality of U-shaped channel frames are equally spaced within the covering panel.

4. The bellows of claim 1, further including a plurality of outer frames having jaws for receiving and securing portions of the covering panel.

5. The bellows of claim 4, wherein a plurality of stiffeners are secured to the channel frames on the floating side.

6. The bellows of claim 5, wherein the stiffeners connect the channel frames to the outer frames thereby trapping the covering panel inside the outer frames.

7. A method of making a bellows comprising:
forming a tube-shaped cover from a generally flat piece of material by securing one edge thereof to another edge thereof;
securing a plurality of U-shaped channel frames to two opposite sides of the tube-shaped cover to create formed sides; and
leaving two sides of the tube-shaped cover adjacent and in-between the formed sides as floating sides without frame members secured thereto.

8. The method of claim 7, further including the steps of securing a plurality of stiffeners to the U-shaped channel frame pieces on the floating sides; and
securing the channel frame pieces to the outer frames on the floating sides, thereby trapping the cover inside the outer frames.
